(19) United States
(12) Patent Application Publication
(10) Pub. No.: US 2008/0220763 A1
(43) Pub. Date: Sep. 11, 2008

(54) Level of Service Determination for a Home Base Station

(76) Inventor: John M. Chapin, Arlington, MA (US)

Correspondence Address: FISH & RICHARDSON PC, P.O. BOX 1022, MINNEAPOLIS, MN, 55440-1022, US

(21) Appl. No.: 11/683,463

(22) Filed: Mar. 8, 2007

(51) Int. Cl. H04Q 7/20

(52) U.S. Cl. 455/422.1

(57) ABSTRACT

In some aspects, a method includes characterizing a communication link established over a network between a home base station and a base station controller. The home base station is configured to send signals to one or more mobile devices and receive signals from the one or more mobile devices. The method also includes determining a level of service to provide by the home base station to the one or more mobile devices based on the characterization of the communication link.

### TECHNICAL FIELD

The following description relates to cellular wireless networks.

### BACKGROUND

In a cellular system voice, data, and signaling traffic is sent between mobile devices and a base station, which is generally located at a cell tower site. The voice, data, and signaling traffic is backhauled from the base station to a base station controller and a mobile switching center.

Most cellular systems were designed to provide coverage to mobile users. These users previously paid significant premiums for mobile telephone service. As a result, mobile phones tended to be used predominantly in automobiles or in locations where landline telephone connections were not conveniently available. As cellular rates have dropped, use of cellular phones has increased. Some sources indicate that as many as 8% of all telephone users no longer have a residential landline and as much as 70% of the call volume on a cellular network is between subscribers each of whom are located within a building (for example and office or residence) when they are making a cellular call.

These changing patterns of use require growth in capacity of cellular networks in order to handle the increased demand. However, they also suggest that cellular networks may be designed differently. The outdoor towers employed by most cellular networks are well suited to provision of services to mobile users. However, they are less well suited to providing coverage indoors because building materials can adversely effect the propagation of signals from and to mobile phones, leading to poor coverage inside buildings. In addition, due to the large size, high power consumption, large capital cost and high operational expense, traditional cellular base stations are very difficult to deploy profitably indoors. Poor coverage within buildings leads to loss of subscribers as they switch between networks seeking better coverage in areas that matter to such subscribers (principally at home and at work).

### SUMMARY

In some aspects, a method includes characterizing a communication link established over a network between a home base station and a base station controller. The home base station is configured to send signals to one or more mobile devices and receive signals from the one or more mobile devices. The method also includes determining a level of service to provide by the home base station to the one or more mobile devices based on the characterization of the communication link.

In some aspects, a system includes a base station communicatively coupled to a communication link, the base station being configured to characterize a communication link established over a network between a home base station and a base station controller, the home base station being configured to send signals to one or more mobile devices and receive signals from the one or more mobile devices. The base station can also be configured to determine a level of service to provide by the home base station to the one or more mobile devices based on the characterization of the communication link.

In some aspects, a computer program product can be tangibly embodied in an information carrier, for executing instructions on a processor. The computer program product can be operable to cause a machine to characterize a communication link established over a network between a home base station and a base station controller, the home base station being configured to send signals to one or more mobile devices and receive signals from the one or more mobile devices. The computer program product can be further operable to cause a machine to determine a level of service to provide by the home base station to the one or more mobile devices based on the characterization of the communication link.

Embodiments can include one or more of the following.

The network can be a shared network. The shared network can be the Internet. Characterizing the communication link can include measuring a bandwidth of the communication link and measuring a latency of the communication link. Characterizing the communication link can include measuring an amount of jitter on the communication link. Determining the level of service can include determining whether to provide data service between the one or more mobile devices and the home base station and determining whether to provide voice service between the one or more mobile devices and the home base station. The method can also include selecting a vocoder based on the characterization of the communication link. The method can also include using the selected vocoder for voice communications between the one or more mobile devices and the home base station. Selecting a vocoder can include selecting one of a full-rate vocoder and a half-rate vocoder. Selecting a vocoder can include selecting a coding rate of an adaptive vocoder. The method can also include providing status indicators to indicate the level of service. The status indicators can include a first indicator configured to indicate a no service condition, a second indicator configured to indicate a level of service in which only data communications are available, and a third indicator configured to indicate a level of service in which voice and data communications are available. The home base station can be a base station configured to be installed by a user inside a dwelling. The home base station can be a base station configured to be installed by a user inside an office building.

It is believed that the home base station can provide the advantage of enabling carriers to provide improved in-home and in building cellular coverage to subscribers who would otherwise have limited or no access to cellular communication in those locations. It is believed that advantages of the home base station can include providing being small, inexpensive to buy, simple to install and/or easy and inexpensive to operate.

### BRIEF DESCRIPTION OF THE DRAWINGS

FIG. 1 is a block diagram of a home base station 16 within a cellular system.

FIG. 2 is a flow chart of home base station configuration process.

FIG. 3 is a flow chart of a service determination process.

FIG. 4 is a flow chart of a location determination process.

FIG. 5 is a flow chart of a location determination process.

FIG. 6 is a diagram of a home base station.

### DETAILED DESCRIPTION

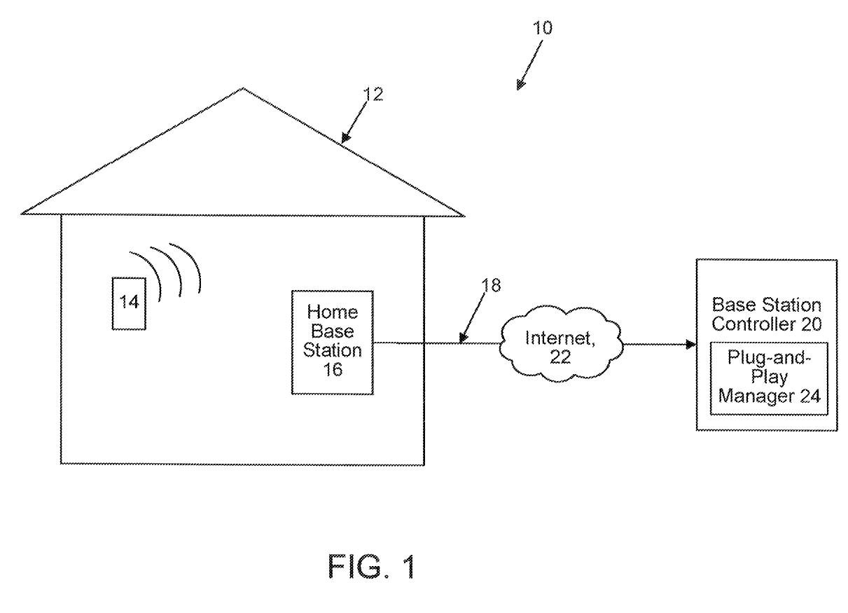

FIG. 1 shows an exemplary architecture 10 of a cellular system employing a home base station 16. This architecture also supports voice, data and signaling communication between a mobile device 14 and the home base station 16 via radio frequency signals. However, the home base station 16 is a low power base station that is not tower mounted as its coverage area is intended to be minimal. In general, the home base station 16 is configured to be installed and operated inside a building such as inside a user's home 12 or inside a user's place of business. The home base station 16 is connected to the base station controller/packet control unit, plug and play manager and media and signaling gateway via a network connection 18, which may employ Ethernet. The network connection 18 optionally may be a connection via the Internet 22 and may employ a virtual private network (VPN) for security.

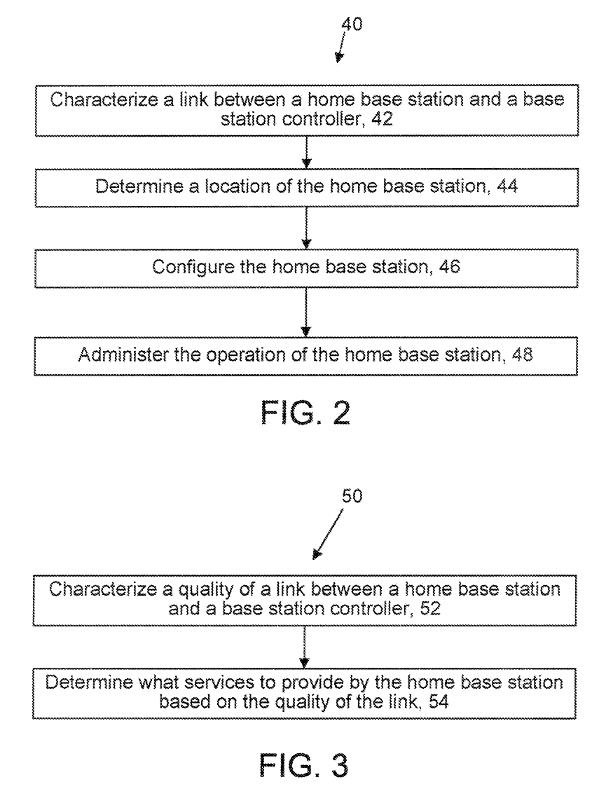

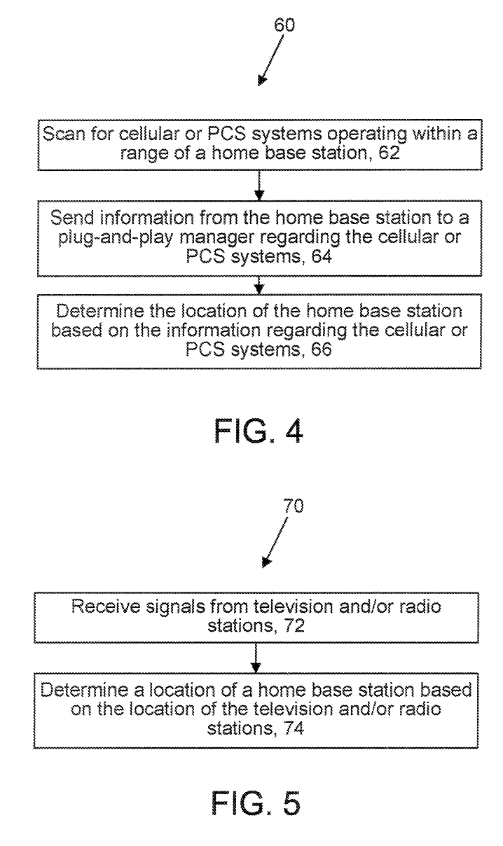

The VPN may be used to support security for the voice or signaling components of traffic carried over the network to or from the home base station 16. The VPN may also be used to communicate with the home base station 16 during base station initialization. As shown in FIG. 2, the initialization and administration process 40 includes several steps, such as characterization of the link between the home base station 16 and the base station controller (42), determination of the location of the home base station 16 (44), configuration of the home base station 16 on the basis of location (46), and administration of base station operation and status and may optionally include spectrum leasing transactions on the basis of location (48). The initialization process can also include downloading base station software download. The initialization and administration process can also include removal or limitation of base station functionality in support of carrier business needs.

Characterizing the Link

The home base station 16, plug and play manager 24, base station controller/packet control unit and media and signaling gateway all tolerate unpredictable variations in bandwidth, latency and jitter introduced by the link 18 between the home base station 16 and the rest of the carriers network. It is an important aspect of the home base station 16 that the link 18 be readily available in location where the home base station 16 is likely to be deployed and that the link be inexpensive. In some embodiments, the Internet may be used as the link, as discussed in the application also assigned to the assignee hereof, “Reducing the Cost of Cellular Backhaul,” application Ser. No. 11/148,953, the contents of which are herein incorporated by reference. If the Internet is used to provide the backhaul link, tolerance of variation in latency, bandwidth and jitter is essential because of the varied performance one can expect from the Internet based on varied demand for services of other Internet users. This tolerance also ensures that the home base station 16 may be used with a wide variety of networks supplying the connection between the home base station 16 and the base station controller 20 at the carrier's central office. In particular, if the Internet is used, competition for resources may have an unpredictable effect on the services available to the home base station 16.

FIG. 3 shows a process 50 for modifying a level of service provided by the home base station 16 based on a characteristic of the link 18. At any time after the network connection has been established and periodically from time to time, the plug and play manager and home base station 16 will exchange messages intended to characterize the quality of the link between them with respect to latency, bandwidth and jitter (52). These measurements will be used at start-up and afterwards to assist the plug and play manager and home base station 16 to determine what services may be provided based on the current attributes of the link between them. For example, if latency is low, bandwidth is high and jitter is not problematic, the home base station 16 might use a full rate vocoder. If bandwidth became constrained, the system might transition to a half rate vocoder, sacrificing some voice quality for the sake of uninterrupted service. Similarly, if latency grew beyond bounds that are tolerable for voice communications, the home base station 16 might suspend voice service, but preserve data services, where high latency is not as disruptive.

In another example, the base station controller can select a waveform to download to the home base station based the characterization of the link between the home base station and the base station controller. For example, if the link had high bandwidth but also high latency, the controller could select a data waveform to take advantage of the high bandwidth. In contrast, if the bandwidth and latency were both low, the controller could select a lower bandwidth waveform suitable for voice communications that also requires less spectrum. If bandwidth was low and latency high, then a low data rate data waveform could be selected in order to minimize spectrum requirements and to acknowledge the reduced feasibility of voice communication in light of the high latency. If the characterization of the backhaul link changes, then the waveform employed could also change.

The home base station 16 can include status indicators such as light emitting diodes that will communicate to the subscriber the condition of the home base station 16 and network or the services then supported on the basis of such conditions. For example, the home base station 16 may have status lights that show network connectivity through green, yellow, or red color, coding denoting good connectivity, poor connectivity (low data rate or high latency suitable for data only, not voice), or no connectivity.

Location Determination

The plug and play manager 24 handles configuration and administration of the home base station 16, including specification of the frequency on which the home base station 16 operates, transmit power of the home base station 16, and configuration of the list of frequencies on which neighboring cell sites operate, for purposes of, among other things, enabling handoffs of mobiles attached to such neighboring cell sites into the home base station 16 and vice versa.

The plug and play manager 24 configures the home base station 16 primarily on the basis of the location of the home base station 16. Location information is critical to configuration because in different locations, a carrier will have authorization to use different portions of the radio frequency spectrum. By identifying the location of the home base station 16, the carrier, through the plug and play manager, can ensure the system only transmits on spectrum licensed to such carrier. If no spectrum is licensed to such carrier in such location, the plug and play manager may provide pertinent data to the carrier to support leasing transactions or other methods of obtaining temporary access to spectrum. In some embodiments, in order to determine the spectrum for operation of the home base station, the base station controller will determine a band of operation for the home base station. Based on the determined band of operation, the base station controller will select and assign a block of operation from the band of operation to the base station. Finally, based on the assigned block of operation, the base station controller can assign a particular channel included in the block to the home base station.

Location information is also critical for E911 support. E911 is the emergency calling service that permits public safety answering points (such as police, fire or EMS dispatchers) to determine where a call originates in order to facilitate public safety response to that call.

Various methods may be used to identify the location of a home base station 16, including GPS, identification of surrounding cellular/PCS transmitters of the carrier's or other carrier's networks and associated power levels, timing of arrival of information transmitted by surrounding cellular/PCS or other RF communication system towers, manual entry by the subscriber or carrier, or other means.

In some embodiments, the home base station system is a software radio in which the receive component of the transceiver is capable of receiving the downlink channels (i.e., the channels on which a mobile station typically receives transmission from the home base station) as well as the uplink channels (i.e., transmissions from mobile stations). In such embodiments, e.g., as shown in FIG. 3, on power up, the home base station 16 will first employ a software application that implements a receiver operating in the same spectrum used by a mobile station receiver in order to scan for cellular or PCS systems operating within range of the home base station 16 (62). The scanning software application may be downloaded to the home base station 16 via the VPN and may be deleted from the home base station 16 following completion of the scanning operation.

The home base station 16 sends to the plug and play manager 24, via the network connection, the information collected regarding surrounding cellular or PCS transmitters (64). Using the information obtained during the scanning phase, the plug and play manager will attempt to identify the home base station's location based on surrounding cell site identification information and power levels at which the transmissions of such cell sites are received (66).

As described below, other means of identifying the location of the home base station 16 are also feasible. The home base station 16 may also receive measurement reports from mobiles attached to the home base station 16 for purposes of determining what other base stations are operating in the vicinity of the home base station 16. These measurement reports may be forwarded to the plug and play manager for frequency planning, system configuration or location determination purposes.

In some embodiments, as shown in FIG. 5, the location of the home base station 16 can be determined based on broadcast signals such as television and radio signals. The home base station 16 receives signals from transmitters such as television stations or radio stations, the positions of which are known (72). The time of arrival of information transmitted by such stations at the home base station 16 will permit the determination of the location of the home base station 16 (74). For example, the location can be determined using the location determination methods described in U.S. Pat. No. 6,492,945 titled “Instantaneous Radiopositioning Using Signals of opportunity” and U.S. Pat. No. 6,559,800 titled “Position Location Using Broadcast Analog Television Signals” the contents of which are hereby incorporated by reference.

Configuration

Once the location of the home base station 16 is determined, the plug and play manager will determine which spectrum, if any, is available for use by the home base station 16 and, within that spectrum, which channels are available. Based on this information, the plug and play manager will configure and download a base station software application to the home base station 16. As a result, the home base station 16 may be shipped by the manufacturer with minimal software installed. For example, the home base station 16 could be configured to contact the plug and play manager via the network connection and could be shipped with no radio software. Similarly, the home base station 16 could be shipped with software to implement various radio receivers to enable or assist location determination, but without transmission software. If each home base station 16 is a generic unit that implements a different standard on the basis of the software it runs, this will allow shipment of the unit to a customer prior to a determination of the standard required by that customer. It will also enable the carrier, via the plug and play manager, to modify the standards being implemented by such home base station unit to adapt to customer requirements, standards migration or other business needs. Finally, it will allow a carrier to alter or eliminate functionality for business or compliance reasons, including elimination or reduction in service based on bill payment or calling plan information or based on interference caused by the home base station to the carriers or other's networks.

The downloaded application will be capable of causing the home base station 16 to both transmit and receive signals in order to communicate with mobile stations or other devices and will be configured to operate in the carrier's licensed spectrum on a designated channel(s). The plug and play manager will download and configure the home base station's base station software application with information regarding surrounding cell sites (e.g., a neighbor list), which communicates to a mobile station those frequencies on which it should look for coverage if the service within its existing cell begins to deteriorate. Similarly, the plug and play manager will also coordinate communication with other elements of the carrier's core and radio access networks in order to reflect the addition of the home base station 16 to the carrier's network at the designated location in the carrier's network configuration. This configuration information will permit the carrier's network to support handover's from the home base station 16 to the rest of the network and vice versa.

In some embodiments, the neighbor list can be populated using downlink scanning software downloaded to the home base station. This software can identify other base stations operating in the vicinity of the home base station based on signals sent by those base stations and can thus populate the neighbor list as well as prevent operation on frequencies that could interfere with the frequencies used by preexisting base stations or other devices emitting signals at a particular frequency.

In the event the carrier does not require handover between the home base station 16 and the rest of the network, the plug and play manager need not propagate information about configuration information downstream to the home base station 16, or laterally throughout the balance of the carrier's network. Similarly, if the carrier requires handover to be operable in one direction, but not the other, the plug and play manager can communicate the required information to either the home base station or the rest of the network, but not both.

Spectrum Leasing

In the event the carrier is not a spectrum licensee in the location of the home base station 16 or in the event the carrier's spectrum in such location is too congested to add another base station, there are several options available to the carrier. The carrier may refuse to provide service in such location and the plug and play manager will not authorize download of base station software. In the alternative, the carrier may seek to use available spectrum in the area, if there is any. This could be accomplished through a direct transaction with a carrier or carriers that are spectrum licensees in the area. It is conceivable that carriers with pre-existing relationships (similar to roaming relationships) would pre-negotiate such spectrum usage rights, facilitating access and lowering transaction costs when the need arises. In such pre-existing relationships, the spectrum lease could be pre-negotiated. Spectrum usage transactions might be billed separately and command premium payments over simple roaming arrangements. In some embodiments, upon connecting the home base station in a location where the carrier does not have a spectrum lease, the user could be notified that the carrier does not have spectrum and be asked if he/she would like to proceed using another carrier's spectrum. For example, the home base station could notify the user (e.g., via a text message on the user's phone or via a display panel on the home base station). The user could additionally be asked to assent to payment of a fee to connect using the leased spectrum. In other embodiments, the home base station could automatically (without requesting input form the user) lease a portion of the spectrum from another carrier and assign a frequency to the home base station based on the leased spectrum. Access to the required spectrum might also be obtained through a spectrum brokerage transaction such as that offered by Cantor Fitzgerald in the United States as of the date of this filing.

Administration and Management

Once the home base station 16 and network have been configured under the direction of the plug and play manager, the plug and play manager and home base station 16 may monitor the health of the VPN and network connection. A disruption of the VPN, the network connection or the power supply to the home base station 16 may cause the system to restart its configuration routine. Following such an outage, the previous configuration information, if stored in the home base station 16, may be used to accelerate configuration by providing preferred settings, which would be quickly verified. If accurate, no reconfiguration may be required. If the location of the home base station 16 has changed, a new configuration may be required.

The VPN may also be used for transmission of operations, administration and maintenance (OA&M) information from the home base station 16 to the plug and play manager 24 or other portions of the network. This will allow the home base station 16 to be monitored for proper operation in a manner similar to other network elements.

The VPN may also be used to administer business rules such as enforcement of terms of business arrangements. For example, if a subscriber chose to pay a monthly fee for use of the home base station system, the carrier might revoke service in any number of ways, including removal of the base station software from the home base station 16. If the carrier still wished to enable emergency calling (911 calls), the network might be configured to only permit those calls.

Finally, the home base station 16 might also be used to receive or transmit other radio frequency signals at times when it is not needed for home base station 16 usage, including, for example, television or broadcast radio signals. These signals could be distributed to other appliances within the home via the network connection to the home base station 16.

User Setup

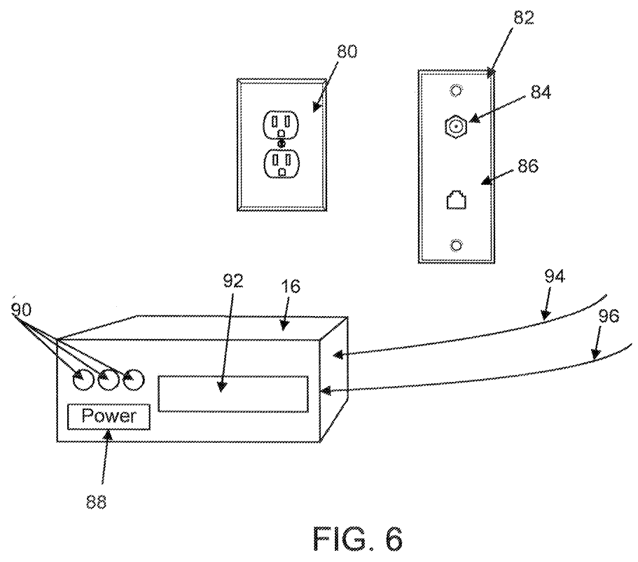

As described above, the home base station 16 automatically determines the user's location. FIG. 6 shows a diagram of an exemplary home base station 16. As shown in FIG. 6, the home base station includes a power button 88, LED status indicator lights 90, and a display panel 92. The LED status indicator lights 90 and display panel 92 can indicate the status of the home base station to a user. Since the home base station 16 automatically determines the user's location, assigns an operating frequency, and populates the home base station's neighbor list, the user-input needed for setup of the home base station is limited. In some implementations, installing and configuring the base station requires at most five actions by the user (e.g., at most four actions, at most three actions, at most two actions, a single action).

In some embodiments, in order to set up the home base station the user is required to complete as few as three steps. The user connects a power cord 96 to a power outlet 80. Once connected, the power outlet 80 provides power to the home base station. The user also connects a communication cable 94 to an internet connection (e.g., to a cable modem connection, an Ethernet connection, a DSL connection, a dial-up phone connection, etc). The user also turns on the device by pressing the power button 88. After the power cord 94 and communication cable 94 have been connected and the home base station has been turned on, the status indicators 90 and display paned 92 indicate the status of the home base station to the user. While in the embodiments described above, the home base station 16 includes separate power and communication cables, in some embodiments the home base station 16 can include a single cable that provides both power and communication capabilities.

Other implementations are within the scope of the following

What is claimed is:

1. A method comprising:
characterizing a communication link established over a network between a home base station and a base station controller, the home base station being configured to send signals to one or more mobile devices and receive signals from the one or more mobile devices; and
determining a level of service to provide by the home base station to the one or more mobile devices based on the characterization of the communication link.

2. The method of claim 1, wherein the network comprises a shared network.

3. The method of claim 2, wherein the shared network comprises the Internet.

4. The method of claim 1, wherein characterizing the communication link comprises:
measuring a bandwidth of the communication link; and
measuring a latency of the communication link.

5. The method of claim 4, wherein characterizing the communication link further comprises measuring an amount of jitter on the communication link.

6. The method of claim 1, wherein determining the level of service comprises:
determining whether to provide data service between the one or more mobile devices and the home base station; and
determining whether to provide voice service between the one or more mobile devices and the home base station.

7. The method of claim 1, further comprising:
selecting a vocoder based on the characterization of the communication link; and
using the selected vocoder for voice communications between the one or more mobile devices and the home base station.

8. The method of claim 1, wherein selecting a vocoder comprises selecting one of a full-rate vocoder and a half-rate vocoder.

9. The method of claim 1, wherein selecting a vocoder comprises selecting a coding rate of an adaptive vocoder.

10. The method of claim 1, further comprising:
providing status indicators to indicate the level of service.

11. The method of claim 10, wherein the status indicators comprise:
a first indicator configured to indicate a no service condition;
a second indicator configured to indicate a level of service in which only data communications are available; and
a third indicator configured to indicate a level of service in which voice and data communications are available.

12. The method of claim 1, wherein the home base station comprises a base station configured to be installed by a user inside a dwelling.

13. The method of claim 1, wherein the home base station comprises a base station configured to be installed by a user inside an office building.

14. The method of claim 1, wherein determining the level of service comprises selecting a waveform based on the characterization of the communication link.

15. A system comprising:
a base station communicatively coupled to a communication link, the base station being configured to:
characterize a communication link established over a network between a home base station and a base station controller, the home base station being configured to send signals to one or more mobile devices and receive signals from the one or more mobile devices; and
determine a level of service to provide by the home base station to the one or more mobile devices based on the characterization of the communication link.

16. The system of claim 15, wherein the network comprises a shared network.

17. The system of claim 16, wherein the shared network comprises the Internet.

18. The system of claim 15, wherein the home base station is further configured to:
measure a bandwidth of the communication link; and
measure a latency of the communication link.

19. The system of claim 18, wherein the home base station is further configured to measure an amount of jitter on the communication link.

20. The system of claim 15, wherein the home base station is further configured to:
determine whether to provide data service between the one or more mobile devices and the home base station; and
determine whether to provide voice service between the one or more mobile devices and the home base station.

21. The system of claim 15, wherein the home base station further comprises status indicators configured to indicate the level of service.

22. The system of claim 21, wherein the status indicators comprise:
a first indicator configured to indicate a no service condition;
a second indicator configured to indicate a level of service in which only data communications are available; and
a third indicator configured to indicate a level of service in which voice and data communications are available.

23. A computer program product, tangibly embodied in an information carrier, for executing instructions on a processor, the computer program product being operable to cause a machine to:
characterize a communication link established over a network between a home base station and a base station controller, the home base station being configured to send signals to one or more mobile devices and receive signals from the one or more mobile devices; and
determine a level of service to provide by the home base station to the one or more mobile devices based on the characterization of the communication link.
